(19) United States
(12) Patent Application Publication
(10) Pub. No.: US 2009/0268471 A1
(43) Pub. Date: Oct. 29, 2009

(54) LENS DEVICE AND ILLUMINATION APPARATUS HAVING THE SAME

(76) Inventors: Chin-Chung CHEN, Chupei City (TW); Lung-Sheng LIN, Chupei City (TW); Ching-Tsung NI, Chupei City (TW); Tsung-Chieh CHEN, Chupei City (TW)

Correspondence Address: HDLS Patent & Trademark Services, P.O. BOX 220746, CHANTILLY, VA, 20153-0746, US

(21) Appl. No.: 12/108,665

(22) Filed: Apr. 24, 2008

(51) Int. Cl. F21V 5/04; G02B 17/00; F21V 17/00

(52) U.S. Cl. 362/335; 359/737; 362/456

(57) ABSTRACT

A lens device used for an LED package includes a base portion, and a refracting portion formed on the top face of the base portion. A recess corresponding to the refracting portion is formed on the bottom face of the base portion. At least one notch connecting with the recess is also formed on the bottom face of the base portion. A surface of refracting portion is provided as a non-spherical convex surface. An indent is formed on the center of the non-spherical convex surface. The light emitted from the LED package is directed toward lateral side, and the angular intensity distribution has an asymmetrical batwing shape, so as to obtain an illuminating apparatus with uniformly illumination.

### BACKGROUND OF THE INVENTION

1. Field of the Invention

The present invention relates to a lens device, and more particularly relates to a lens device used for generate asymmetrical light distribution.

2. Description of Related Art

Light emitting diode (LED), as a solid-state semiconductor device to emit light, has advantages of small volume, long life duration, low power consumption, fast response rate and shockproof ability, and is already comprehensively used as a light source of electronic products, information displays or communication products.

Conventional side emitting LED package, such as Taiwan patent No. 262604 disclosed, usually includes a lens therein to laterally guide light emitted from an LED chip. The lens has a bottom face facing the LED chip, a reflecting face opposite to the bottom face, and a refracting face perpendicular to the direction of light output. The reflecting face is a symmetrically parabolic surface. The LED is located at the focal point of the parabolic surface. Light entered through the bottom face into the lens is reflected by the reflecting face to the refracting face and then perpendicularly exits the lens from the refracting face.

Another lens disclosed in Taiwan patent publication No. 200402899 includes a bottom face, a reflecting face, a first refracting face obliquely angled with respect to a central axis of the lens, and a smooth curved second refracting face extended from the bottom face to the first reflecting face. Light entered through the bottom face into the lens is reflected by the reflecting face to the first refracting face and then exits the lens from the first refracting face in a direction substantially perpendicular to the central axis of the lens. In another aspect, light entered through the bottom face into the lens and then propagated to the second refracting face also exits from the second refracting face in a direction substantially perpendicular to the central axis of the lens. Consequently, a side emitting LED apparatus is able to be provided by coupling the above-mentioned lens with a LED chip.

However, the refracting faces of the conventional lenses are free-form surfaces. The irregularity of the free-form surfaces makes the corresponding molds for manufacturing the lenses difficult to prepare, even by the aided of computer assisted design techniques, and the manufacturing costs thereof is increased.

Moreover, another lens for LED package disclosed in Taiwan patent publication No. 200507293 is consisted of a plurality of refracting portions. Each of the refracting portions has its face with different curvature. The lens with many refracting portions may be fabricated in a one-piece form. Besides, the LED package includes a carrier and an LED chip arranged on the carrier. The lens encapsulates the LED chip on the carrier to guide light emitted from the LED chip toward the lateral side of the lens.

However, the above-mentioned LED package requires multiple steps of encapsulating to form the lens consisted of multiple refracting portions. The dimensions of the lens limit the applications of the lens with different types of LED package.

### SUMMARY OF THE INVENTION

It is the object of the present invention to a lens device for coupling to an LED package with the central axis of the lens device deviating from the central axis of the LED package. Such that, light emitted from LED package is guided toward the lateral side of the LED package, and the angular intensity distribution thereof is of asymmetrical batwing shaped. It is able to obtain an illumination apparatus with uniformly illuminating and higher light utilization efficiency by applying the lens device.

Accordingly, the invention provides a lens device including a base portion and a refracting portion arranged on the top face of the base portion. A recess corresponding to the refracting portion is defined on the bottom face of the base portion. At least one notch connecting the recess is formed on the bottom face of the base portion. The recess is used for containing a LED package therein. At least one electrical lead of the LED package is extended through the notch to the outside of the base portion. Besides, pluralities of positioning members are formed on the bottom face to position the lens device on a corresponding circuit board precisely. A non-spherical convex surface is provided on the refracting portion. An indent is formed on the center of the non-spherical convex surface.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a perspective view of a lens device according to an embodiment of present invention;

FIG. 2 shows another perspective view of the lens device in FIG. 1;

FIG. 3 shows a cross-section view of the lens device in FIG. 1;

FIG. 4 shows a perspective view of the lens device coupled to an LED package;

FIG. 5 shows a cross-section view of the lens device coupled to the LED package;

FIG. 6 shows a top view of the lens device coupled to the LED package;

FIG. 7A is a diagram showing the angular intensity distribution of light emitted from the lens device while the center axis of the lens device is coincided with the center axis of the LED package;

FIG. 7B is a diagram showing the angular intensity distribution of light emitted from the lens device while the center axis of the lens device is deviated from the center axis of the LED package; and

FIG. 8 shows a perspective view of a lens device according to another embodiment of present invention.

### DETAILED DESCRIPTION OF THE INVENTION

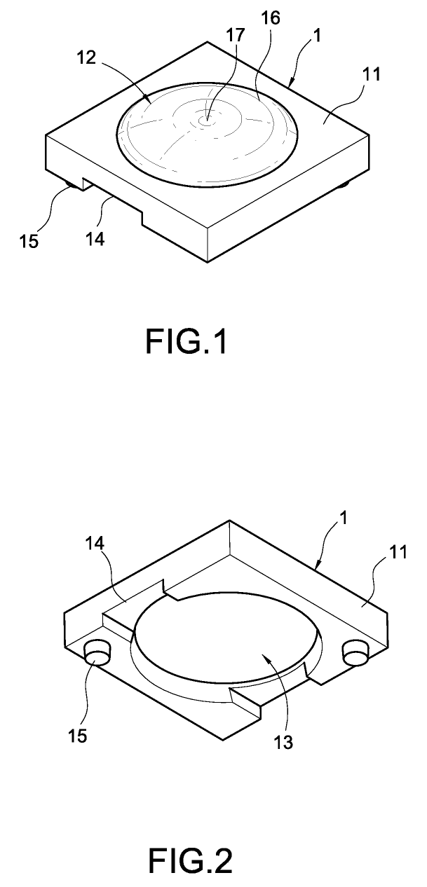

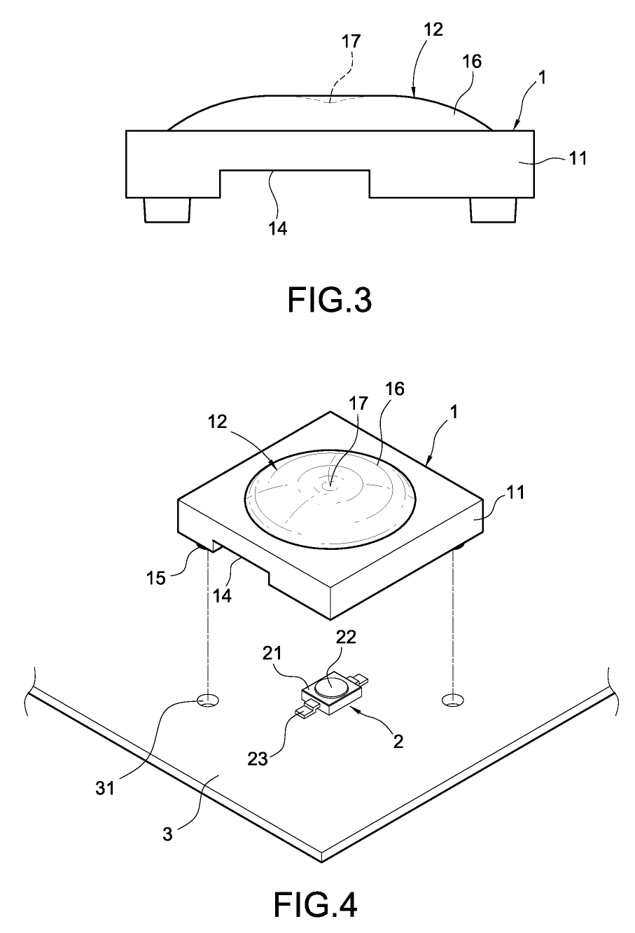

FIG. 1 and FIG. 2 show a lens device 1 according a preferred embodiment of the present invention. The lens device 1 includes a base portion 11 and a refracting portion 12 arranged on the center of the top face of the base portion 11. A recess 13 corresponding to the refracting portion 12 is formed on the bottom face of the base portion 11. Two notches 14 connecting the recess 13 are formed on the bottom face of the base portion 11. Pluralities of positioning members 15 are formed on the bottom face of the base portion 11. In this embodiment, the positioning members 15 are of rod-like shaped. A non-spherical convex surface 16 is provided on the refracting portion 12. An indent 17 is formed on the center of the non-spherical convex surface 16.

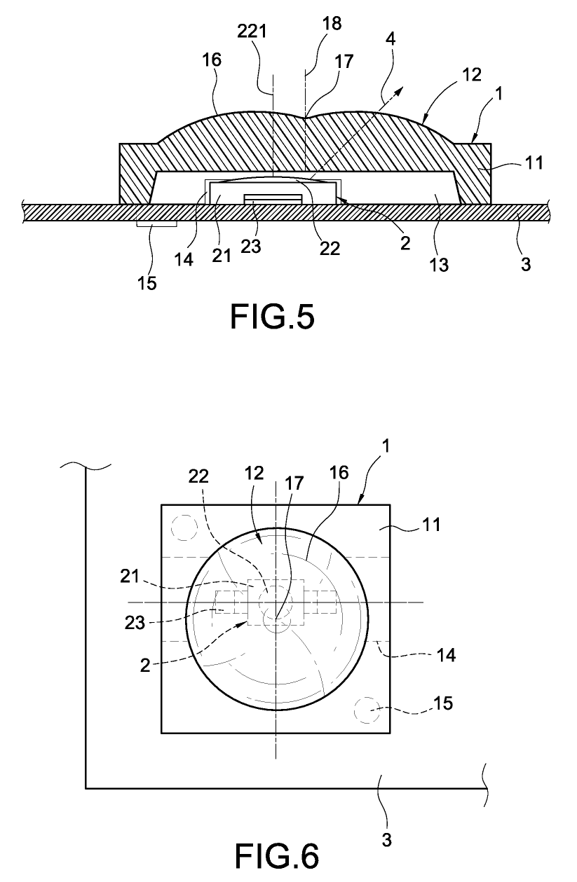

FIG. 4 and FIG. 5 show a lens device 1 coupled to an LED package 2 on a circuit board 3 according to an embodiment of present invention. The LED package 2 includes a mount 21, a lens 22 arranged on the mount 21, and a plurality of electrical leads 23 extended from the mount 21. A plurality of positioning ports 31 corresponding to the positioning members 15 are formed on the circuit board 3. The electrical leads 23 are electrically connected with circuit (not shown) on the circuit board 3. The lens device 1 is arranged on the circuit board 3 with the LED package 2 contained in the recess 13 of the lens device 1. The electrical leads 23 of the LED package 2 are correspondingly contained in the notches 14 or extended through the notches 14. The positioning members 15 of the lens device 1 are correspondingly positioned into the positioning ports 31 on the circuit board 3. With the design of the recess 13 and the notches 14, the lens device 1 is capable to precisely couple with various types of LED packages. In this embodiment, the positioning ports 31 are a plurality of holes formed on the circuit board 3.

As FIG. 5 and FIG. 6 show, the center axis 18 of lens device 1 is arranged to deviate from the central axis 221 of the LED package 2. When the LED package 2 is powered on, light 4 emitted from the LED package 2 will be guided to the lateral side of LED package 2 by the refracting portion 12.

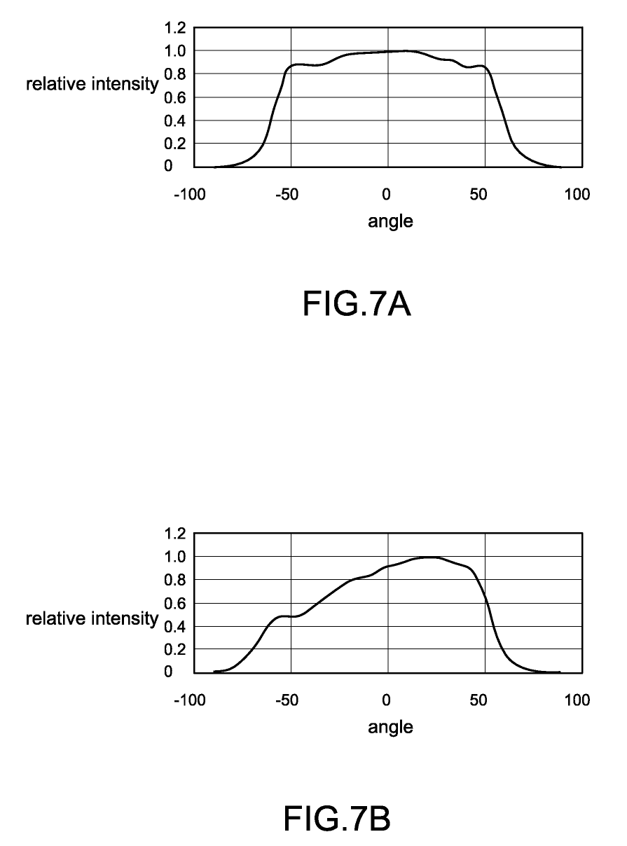

FIG. 7A is a diagram of angular intensity distribution of light emitted from the lens device 1 in case that the center axis 18 of the refracting portion 12 is aligned with the center axis 221 of the lens 22. The peak of the distribution pattern is located between the angular ranges of −50 to 50 degree.

FIG. 7B is a diagram of angular intensity distribution of light emitted from the lens device 1 in case that the center axis 18 of the refracting portion 12 deviates from the center axis 221 of the lens 22. The peak of the distribution pattern is shifted to around 25 degree in comparison to that in FIG. 7A, and the angular intensity distribution has an asymmetrical batwing shape. As a consequent, it is able to obtain an illumination apparatus with uniformly illuminating and higher light utilization efficiency by applying the lens device 1 thereon.

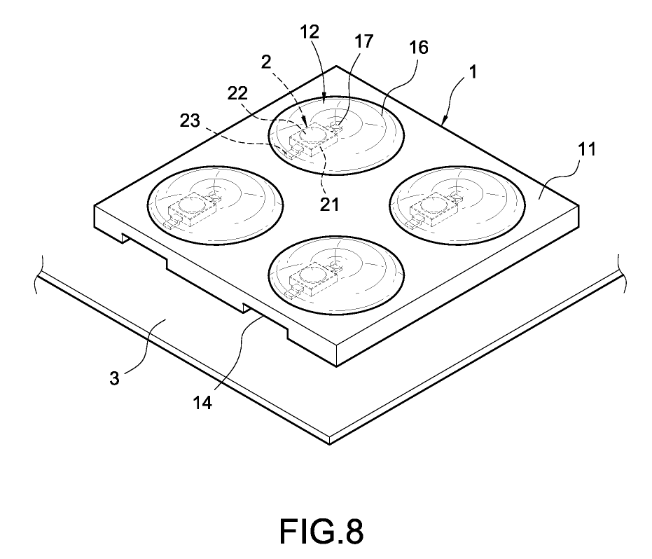

FIG. 8 shows the lens device 1 coupling to a LED package 2 on a circuit board according to another embodiment of present invention. The difference between the lens device 1 in FIG. 6 and the lens device 1 in FIG. 1 is that there are pluralities of refracting portions 12 arranged on a top face of a base portion 11. Each of the refracting portions 12 is correspondingly arranged on a LED package 2 on the circuit board 3. Not only an illumination apparatus with uniformly illuminating is obtained, but also the manufacturing steps and costs thereof are decreased.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A lens device used for a light emitting diode (LED) package, the lens device comprising:
a base portion; and
at least one refracting portion arranged on a top face of the base portion and comprising a non-spherical convex surface,
wherein a recess corresponding to the refracting portion is formed on the bottom face of the base portion and an indent is formed on the center of the non-spherical convex surface.

2. The lens device in claim 1, wherein a notch connecting with the recess is formed on a bottom face of the base portion.

3. The lens device in claim 1, wherein a plurality of positioning members are formed on a bottom face of the base portion.

4. The lens device in claim 3, wherein the positioning members are of rod-like shaped.

5. An illumination apparatus, comprising:
a circuit board;
at least one light emitting diode (LED) package arranged on the circuit board and comprising a lens; and
a lens device arranged on the circuit board and containing the LED package, the lens device comprising:
a base portion; and
at least one refracting portion arranged on a top face of the base portion and comprising a non-spherical convex surface,
wherein a recess corresponding to the refracting portion is formed on a bottom face of the base portion to contain the LED package and an indent is formed on the center of the non-spherical convex surface.

6. The illumination apparatus in claim 5, wherein a plurality of positioning ports are formed on the circuit board.

7. The illumination apparatus in claim 6, wherein the positioning ports are a plurality of holes formed on the circuit board.

8. The illumination apparatus in claim 6, wherein a notch connecting with the recess is formed on the bottom face of the base portion.

9. The illumination apparatus in claim 5, wherein a plurality of positioning members are formed on the base portion.

10. The illumination apparatus in claim 9, wherein the positioning members are of rod-like shaped.

11. The illumination apparatus in claim 5, wherein the LED package comprises two electrical leads connected with the circuit board.
